(19) United States
(12) Patent Application Publication
(10) Pub. No.: US 2009/0075046 A1
(43) Pub. Date: Mar. 19, 2009

(54) AQUEOUS BASED COATING WITH ATTRACTIVE BARRIER AND OPTICAL CHARACTERISTICS

(75) Inventors: Richard T. Fox, Midland, MI (US); Huiqing Zhang, Midland, MI (US); Chan Han, Midland, MI (US); Michael S. Paquette, Midland, MI (US); Richard F. Fibiger, Midland, MI (US)

Correspondence Address: THE DOW CHEMICAL COMPANY / DOBRUSIN & THENNISCH PC, 29 W. LAWRENCE STREET, STE. 210, PONTIAC, MI, 48342, US

(73) Assignee: Dow Global Technologies, Inc.

(21) Appl. No.: 12/205,239

(22) Filed: Sep. 5, 2008

Related U.S. Application Data
(60) Provisional application No. 60/972,874, filed on Sep. 17, 2007.

(51) Int. Cl. B32B 3/26; C08K 3/34; B32B 7/02; B32B 27/00

(52) U.S. Cl. 428/215; 524/442; 428/336; 428/319.3

(57) ABSTRACT

An improved coating composition including a polymeric component and synthetic clay. The coating composition is particularly useful for coating a polymeric substrate, such as a styrenic polymeric substrate. One particular preferred application involves coating a closed cell foam extruded styrenic polymeric insulation panel with the coating composition, thereby realizing attractive barrier properties and optical characteristics from the coating.

### CLAIM OF PRIORITY

The present application claims the benefit of the filing date of U.S. Provisional Application No. 60/972,874 (filed Sep. 17, 2007) the teachings of which are incorporated by reference herein.

### FIELD OF THE INVENTION

The invention relates to coatings for polymeric substrates, and specifically styrenic polymeric foam substrate coatings that employ synthetic clay for realizing attractive barrier and optical characteristics.

### BACKGROUND

There is a need for many materials and structures to minimize the inward diffusion of ambient gasses, the outward diffusion of entrapped gasses or both. With insulation materials, in particular, for retaining high thermal resistance (i.e. R-values), it would be especially attractive to retard the effects of such diffusion. Among the many possible techniques for improving short and long term resistance to ambient gas diffusion is to employ a barrier coating.

For certain polymeric insulation materials, efforts to employ barrier coatings on an insulation material substrate have been hampered by one or more factors, such as the incompatibility of the substrate with the solvent of the barrier coating, the management of volatile organic compound emissions, poor adhesion of the coating to the substrate, poor wetting characteristics of the coating on the substrate material, as well as optical characteristics of the coating that exhibit undesired discoloration.

It would be attractive to have a coating composition that overcomes one or more (and preferably all) of the above difficulties. It would also be especially attractive for such coating composition to be water-based, for helping to avoid the potential effects of volatile organic compounds.

An example of one effort to develop an aqueous composition for a barrier coating of a polymeric substrate is illustrated in U.S. Pat. No. 6,087,016, incorporated by reference. That patent discloses a coating composition, useful for coating a tire, which includes a surfactant and high aspect ratio natural clay particles as filler. Barrier coatings employing specific polymers and specifically treated clays are discussed in Published U.S. Application Nos. 20050228104 and International Application Published under the Patent Cooperation Treaty (PCT Application) Nos. WO 2005044938, WO 2005061608, and WO 2005063871, all incorporated by reference. See also, PCT Application Nos. WO 98/56861; WO 98/56598; European Patent No. EP991530B1; and Zilg et al, “Polyurethane Nanocomposites Containing Laminated Anisotropic Nanoparticles Derived from Organophilic Layered Silicates,” Adv. Mater, 1999, 11, No. 1; all incorporated by reference.

### SUMMARY OF THE INVENTION

In one aspect, the present invention meets the above needs by providing an improved coating composition including a polymeric component, including styrene, butadiene, butyl rubber, (meth)acrylate, polyurethane, or a combination thereof; and synthetic clay, wherein the coating composition will exhibit, in the form of a dry coating layer of less than 2 mils thickness, (i) a coating permeability (according to ASTM D3985-05 (at a temperature of 23° C. and 60 to 80% RH)) of about 0.01 to about 6 cc-mil/100 in²-Day-atm; and (ii) a yellowness index (according to ASTM E313-00) of less than about 6. The coating composition is particularly useful for coating a polymeric substrate, such as one including polystyrene.

Particular embodiments of this aspect include one or any combination of the following additional characteristics: the polymeric component and the synthetic clay each include particles dispersed in water; the polymeric component consists essentially of styrene-butadiene copolymer or a polyurethane; the synthetic clay includes a swellable synthetic clay; the synthetic clay consists essentially of a synthetic tetrasilicic fluoromica clay; the composition is prepared according to a method that includes the steps of providing a polymeric dispersion including particles of the polymeric component, and thereafter adding to the dispersion a sufficient amount of a synthetic clay (optionally provided from a dispersion that included the synthetic clay and a de-flocculant) for improving the ability of the resulting coating to resist gas diffusion over time, the ability to provide a generally transparent optical characteristic with only insubstantial (if any) yellowing, or both; the synthetic clay is employed in an amount of about 3 to about 40 weight percent of the total solids content of the coating composition; the polymeric component and the synthetic clay are both dispersed as particles in an aqueous medium that excludes volatile organic compounds; the particles of the synthetic clay have an average particle aspect ratio of about 2000:1 to about 10:1 (e.g., about 1500:1 to about 100:1); the composition is free of any added surfactant; the composition is in the form of a coating layer on a substrate (e.g., the composition is in the form of a coating layer having a thickness of less than about 0.03 mm (1 mil) on a polymeric substrate that includes a polystyrene-containing material); or the coating composition will exhibit (i) a coating permeability (according to ASTM D3985-05 (at a temperature of 23° C. and 60 to 80% RH)) of less than about 2.5 cc-mil/100 in²-Day-atm; (ii) a yellowness index (according to ASTM E313-00) of less than about 4; or (iii) a combination of (i) and (ii).

Articles according to the teachings herein may be prepared by a method that includes a step of contacting a substrate as described herein with the coating composition. Thus, for example, one such method includes a step of contacting an elongated extruded styrenic polymeric substrate, including a network of closed cells containing a gas or gas mixture that is free of chlorofluorocarbons (i.e., a CFC-free gas phase), with the herein-described coating composition.

Thus, in another aspect the present invention contemplates a coated article that includes a substrate; and a coating on the substrate that has a thickness less than about 1 mil, and that includes a polymeric component selected from styrene-butadiene or polyurethane, and a synthetic tetrasilicic fluoromica clay including about 3 to about 40 percent by weight of coating solids of clay particles that have an average effective aspect ratio of about 2000:1 to about 10:1; wherein the coating will exhibit in the form of a dry coating layer of less than 1 mil thickness (i) a coating permeability (according to ASTM D3985-05 (at a temperature of 23° C. and 60 to 80% RH)) of about 0.01 to about 6 cc-mil/100 in²-Day Atm (ii) a yellowness index (according to ASTM E313-00) of less than about 6, and more preferably less than about 4; or (iii) a combination of (i) and (ii).

The article may further be characterized by one or any combination of the following features: the coating composition will exhibit, in the form of a dry coating layer of less than 1 mil thickness, (i) a coating permeability (according to ASTM D3985-05 (at a temperature of 23° C. and 60 to 80% RH)) of about 0.1 to about 3 cc-mil/100 in²-Day-atm; the substrate is an elongated styrenic polymeric insulation member having a thickness from about 10 mm to about 100 mm; the substrate includes a generally planar surface to which the coating is contacted, a generally arcuate surface to which the coating is contacted, or both; at least a portion of the substrate includes a network of closed cells containing a CFC-free gas phase, the substrate is free of voids between walls defining the cells, or both; the substrate exhibits a combination of the following properties: a) a thermal resistance value at one inch (25.4 mm) thickness of at least about two ft²*hr*° F./Btu (0.35 m²*K/W), according to ASTM C578-06; b) a minimum compressive strength (psi, (kPa) per ASTM D1621-04A, at the first of 10% deformation or yield) of at least about 13 psi (90 kPa); c) a minimum flexural strength (psi, (kPa) per ASTMC203) of at least about 30 (208); and (d) a maximum dimensional stability value (% linear change per ASTM D2126-04) of about 4; the substrate includes a colorant for imparting a substantially uniform color throughout the substrate; or in a very preferred aspect, the substrate is an elongated extruded polystyrene-containing substrate (i) including a network of closed cells containing a CFC-free gas phase, having an average cell size of about 0.1 to about 1 mm per ASTM D3576-04, and (ii) exhibiting a combination of the following properties: (a) a thermal resistance value at one inch (25.4 mm) thickness of at least about two ft²*hr*° F./Btu (0.35 m²*K/W), according to ASTM C578-06; (b) a minimum compressive strength (psi, (kPa) per ASTM D1621-04A, at the first of 10% deformation or yield) of at least about 13 psi (90 kPa); (c) a minimum flexural strength (psi, (kPa) per ASTMC203) of at least about 30 (208); and (d) a maximum dimensional stability value (% linear change per ASTM D2126-04) of about 4; the coating on the substrate has a thickness less than about 1 mil, and includes a polymeric component selected from styrene-butadiene or polyurethane, and a synthetic tetrasilicic fluoromica clay including about 5 to about 30 percent by weight of coating solids of clay particles that have an average effective aspect ratio of greater than about 450:1; and wherein the coating will exhibit in the form of a dry coating layer of less than 1 mil thickness a coating permeability (according to ASTM D3985-05(at a temperature of 23° C. and 60 to 80% RH)) of less than about 2.5 cc-mil/100 in²-Day Atm, a yellowness index (according to ASTM E313-00) of less than about 4, or both.

Among the benefits of the invention is the ability to readily adapt various commercially available latex dispersions and render them suitable for barrier coating applications. In one aspect, the invention contemplates steps of providing a previously formulated polymeric dispersion (e.g., a previously formulated dispersion including particles that have been at least partially if not fully polymerized) and thereafter adding to the dispersion a sufficient amount of a synthetic clay for improving the ability of the resulting coating to resist gas diffusion over time, the ability to maintain a generally transparent optical characteristic with only insubstantial (if any) yellowness, or both. In one aspect, the resulting dispersion does not require the addition of any surfactant beyond that which existed for maintaining particle stability in the original previously formulated polymeric dispersion provided. Thus, methods of making the compositions herein may be free of any step of adding surfactant with the provided polymeric dispersion.

Another benefit that may be realized according to the teachings of the present invention is the ability to coat certain substrates, particularly substrates having relatively low surface energy characteristics (e.g., polymeric substrates such as those made from a polystyrene or a polyolefin) to improve the barrier characteristics of the material. Coated articles (such as coated insulation panels or coated packaging materials) are thus contemplated as within the teachings of the present invention.

### DETAILED DESCRIPTION OF THE PREFERRED EMBODIMENT

As used herein, the following abbreviations shall have the following meaning:

| | |
|---|---|
| atm | atmosphere |
| in | Inch |
| cm | centimeter |
| cc | cubic centimeter |
| mil | 1/1000^{th} of an inch |
| μ | micron |
| Pa | Pascal |
| psi | Pounds per square inch |
| M | Mega (10⁶) |
| k | Kilo (10³) |
| ° F. | Temperature (degrees Fahrenheit) |
| ° C. | Temperature (degrees Celsius) |
| K | Temperature (Kelvin) |
| Btu | British Thermal Units |
| W | watts |
| RH | Relative humidity |
| g | grams |
| OTR | oxygen transmission rate |
| ASTM | A designation to denote a standard issued by the standards developing |
| | organization operating under the name ASTM International or American |
| | Society for Testing and Materials (www.astm.org); unless otherwise denoted |
| | (e.g., by a year in the suffix, such as “-00” or “-2000” referring to the 2000 |
| | version), the standards employed herein refer to the most recent standard |
| | issued by ASTM International under the designation as of the application |
| | filing date. |
| ISO | A designation to denote a standard issued by the standards developing |
| | organization operating under the name International Organization for |
| | Standardization (www.iso.org); unless otherwise denoted (e.g., by a year in |
| | the suffix, such as “-00” or “-2000” referring to the 2000 version), the |
| | standards employed herein refer to the most recent standard issued by ISO |
| | under the designation as of the application filing date. |

The invention herein contemplates a unique combination of materials employed for achieving attractive barrier properties, optical characteristics or both in a resulting coated article. Though finding particular use for fabricating coated insulation materials, such as coated polymeric foam insulation panels, the coating compositions herein are not limited to such application, and may find attractive use elsewhere, such as in packaging materials or other applications for which improved long-term barrier properties, optical transparency or both are desired.

In general, the present invention is based upon unexpected and surprising results believed obtainable by the employment of certain synthetic clay materials, in a dispersion of polymeric particles. More specifically, the present invention is based upon the recognition that, when employed as an ingredient in a barrier coating composition, synthetic clays (particularly fluoromica synthetic clays) mix with certain aqueous polymeric particle dispersions (e.g., (meth)acrylic dispersions, butyl rubber dispersions, styrenic dispersions, polyurethane dispersions, butadiene dispersions, or any combination thereof, and specifically styrene-butadiene dispersions, or polyurethane dispersions), for providing a resulting dispersion that readily wets substrates and results in one or both of excellent barrier properties or excellent optical transparency characteristics for resisting coloration. Accordingly, the invention finds attractive use for coating a variety of substrates, especially polymeric substrates, such as polystyrene-containing foam substrates (e.g., extruded closed cell foam polystyrene substrates) useful in the construction industries, the packaging industries, or otherwise.

In general, the compositions herein desirably employ a water-based dispersion of one or more polymeric particles (e.g., a latex). Though other polymers may be employed, such as is indicated above, a particularly preferred composition is a water-based dispersion including polyurethane particles, styrene-containing particles (such as particles including or consisting essentially of a copolymer of styrene and butadiene), or a combination thereof. The water-based dispersion may be formulated to include other ingredients as well. For example, it is possible that the water-based dispersion (particularly prior to admixing with any synthetic clay particles) may include a surfactant, but preferably in an amount no greater than is needed to maintain the polymeric particles dispersed in the water. The polymeric particles of the compositions herein, though dispersable in water, are insoluble in water. The dispersions here typically will be free of silane compounds and cross-linking agents. It is further contemplated that the polymeric particles do not cross link upon application of heat.

By way of illustration, one suitable water-based dispersion excludes any volatile organic compound, and will include a polyurethane polymer, and particularly a polyurethane/polyurea polymer. The polyurethane polymer may be prepared by any art-disclosed technique, such as one involving a reaction of an isocyanate and a polyol. One particular preferred approach is to employ a reaction product of an isocyanate and a polyol. It is contemplated that one suitable waterborne polyurethane dispersion in accordance with the above will be free of tertiary amines, free of residual isocyanate or both. Typically, the polymeric particles will make up about 40 to about 60% by weight of the dispersion prior to being admixed with the synthetic clays herein. One preferred example of a suitable waterborne polyurethane is described in PCT Application No. WO 2007/027921, hereby expressly incorporated by reference.

More specifically, by way of example, one preferred dispersion includes an aqueous polyurethane dispersion containing polyurethane solids, which has a maximum non-aqueous, organic solvent content of less than 5 weight percent (and more preferably is free of any non-aqueous, organic solvent), wherein the polyurethane solids are obtained from a polyurethane prepolymer prepared by reacting (e.g., in a continuous process) (a) a polyol or polyol blend having a mean average equivalent weight of 240 to 480 (e.g., one or more diols, polyether polyols, or both), and (b) at least one polyisocyanate (e.g., an aliphatic or aromatic isocyanate) (c) optionally additional stabilizers; and (d) optionally, one or more chain extenders such as a polyamine, an amine terminated polyether or a combination of both (e.g., an aminated polypropylene glycol like that available from Huntsman under the designation JEFFAMINE D230) wherein the prepolymers have an isocyanate (NCO) content of from 8 to 13 weight percent and the polyisocyanate to polyol molar ratio is from 2.0:1 to 3.0:1; with the proviso when the equivalent weight of the polyol or polyol blend is less than 260, a chain extender is present. The polyurethane solids are preferably formed by reaction prior to mixing with any synthetic clay herein.

By way of further illustration, another suitable waterborne dispersion is free of any volatile organic compound, and will include styrene-containing polymeric particles, and specifically a latex including or consisting essentially of styrene-butadiene co-polymer. Typically, the polymeric particles will make up about 40 to about 60% by weight of the dispersion prior to being admixed with the synthetic clays herein. One preferred example of a suitable waterborne styrene-butadiene dispersion is available from The Dow Chemical Company under the designation Latex DL 460NA.

A preferred synthetic clay for use herein is a synthetic layered silicate. A particularly preferred synthetic clay is a synthetic mica clay, such as a fluorine mica, and specifically a tetrasilicic fluoromica clay. Suitable synthetic clays thus generally will include, without limitation, synthesized compounds that include silicon (Si), magnesium (Mg), oxygen (O), hydrogen (H), sodium (Na), and fluorine (F). Synthetic clay compounds herein may also include silicates with one or more of lithium (Li), aluminum (Al) or potassium (K). For examples, the synthetic clays may include oxygen-containing silicate compounds that include one or more of Mg, H, Na, F, Li, Al or K. The present invention contemplates that the synthetic clays herein may be prepared and processed free of any functionalizing of the clays with an organic functionality, an acid, or a base. The synthetic clays may be prepared under controlled synthesis conditions, such as by a precipitation process, a thermal or hydrothermal synthesis process, or any combination thereof. For example, the synthetic clays may be derived by heating (e.g., in an electrical furnace) talc and Na₂SiF₆, K₂SiF₆, or a combination of both, according to art-disclosed techniques. It is believed that by synthesizing clay, rather than purifying natural clay, a more consistent structure of fine lamellar platelets is achievable, with platelet lamellae that are smaller than natural clays, and with an average particle size on the order of about ¼ to 1/10 that of corresponding natural clays being possible. It is also possible that the synthetic clays will have a larger average particle size, and may even have an average particle size that is larger than its corresponding natural clay. The resulting synthetic clays generally will be free of organic impurities, such as cellulose, lignins, or the like, which are common in natural clays. The resulting synthetic clays can also be free of inorganic compounds typically found in natural clays, such as iron, silicon, or calcium compounds. For example, it is contemplated that the synthetic clays herein will be free of one or more naturally occurring compounds selected from feldspar, quartz, mica, calcite, kaolinite, or dolomite. However, it is possible that a compound may be present incidentally from the production of the synthetic clay. For example, the synthetic clay may include cristobalite.

Because there is a significantly higher control over starting materials, as compared with natural clays, the selection of synthetic clay materials having tightly controlled and attractive properties such as color, particle dispersion capability, ion exchange values, or even particle morphology (e.g., diameter, thickness, aspect ratio), allows for predictable properties of the coating compositions that will be consistent from batch to batch.

The synthetic clays useful herein may exhibit an average particle diameter (D50) of about 15 microns or smaller, more specifically about 7 microns or smaller, and still more specifically about 2 microns or smaller. For example, the average particle diameter may be less than about 1 micron, and still more specifically less than about 0.5 micron. For high-aspect ratio synthetic clays, the synthetic clays could exhibit a particle thickness as low as about 10 nm or smaller. In one aspect, for assisting to impart improved barrier properties, it is desirable to employ synthetic clays that have a relatively high aspect ratio. Accordingly, it is possible that the synthetic clays herein will have an average particle aspect ratio (ratio of particle diameter to particle thickness) of from about 2000:1 to about 10:1, and more specifically about 1500:1 to about 100:1, and still more specifically about 1050:1 to about 450:1. Thus, for example, the average particle aspect ratio may be greater than about 10:1, more preferably greater than about 100:1, and still more preferably greater than about 450:1.

As discussed in WO 98/56861, incorporated by reference, the average particle aspect ratio of the clay particles in a final coating may not wholly reflect the true aspect ratio of the particles, due to the possibility of bundles or agglomerates of the particles. It is expected, nonetheless that the resulting “effective aspect ratio” as taught in WO 98/56861 (identifying determination by reference to E. L. Cussler et al, J. Membrane Sci., 38: 161:174 (1988)), incorporated by reference, will be a value within about 20% of the above-recited aspect ratio values. The density of the synthetic clays may be about 2.5 to about 2.7 g/cm³. As gathered from the above, particle dimensions herein may be measured by electron microscopy (e.g., Scanning Electron Microscopy or Transmission Electron Microscopy), by light scattering methods (e.g., by passing the particles through a laser light diffraction analyzer, such as a MICROTRAC® S3500 analyzer, in accordance with ISO 13320-1:1999).

One example of a preferred class of synthetic clays is a swellable clay, and specifically a swellable mica clay. Such clay may be hydrophilic or organophilic.

An example of a commercially available synthetic clay is offered under the designation SOMASIF™, by Co-Op Chemical Co., Ltd. (e.g., under the grade ME-100). Suitable synthetic Na tetrasilicic mica clays are also available from Topy Industries, Ltd. such as under the designation DMA-350, NTS or NHT.

Other synthetic clays may be employed, as well, such as synthesized layered silicates (e.g., saponites (sodium magnesium aluminum silicates), such as that available from Kunimine Industries Co., Ltd., under the designation SUMECTON SA); hectorites (sodium lithium magnesium silicates), such as that available from Southern Clay Products, Inc. under the designation LAPONITE®, from Sued Chemie under the designation Optigel® SH, or from Co-Op Chemical Co., Ltd. under the designation LUCENTITE SWN; mica-montmorillonite (sodium lithium aluminum silicate), such as that available from NL Industries, Baroid Division, under the designation BARASYM SSM-100. Another example of suitable synthetic clay may include tainiolite. Synthetic clays may include fluorine. For example, it may be a fluorohectorite (sodium lithium magnesium silicate fluoride), such as is available from Co-Op Chemical Co., Ltd. under the designation LUCENTITE SWF. The synthetic clays desirably will include sodium, but need not in every instance.

Other ingredients may be employed (e.g., in their art-disclosed amounts) in the present compositions, including but not limited to an ingredient selected from flame retardants, colorants, rheology modifiers, anti-foam agents, de-flocculants, biocides, fungicides, thermal stabilizers, light stabilizers, adhesion promoters, surfactants or any combination thereof. Though it may be possible that surfactants are added for tuning performance of the resulting dispersions herein, one particular benefit achievable in the practice of various embodiments of the present invention is that it is not necessary to add a surfactant for sufficiently dispersing the synthetic clay. Thus the present invention contemplates compositions that include a latex as described herein, a synthetic clay, and is free of any added surfactant, and especially any polymeric or other organic surfactant. For example, the coatings herein may be free of any added siloxane-based surfactant. Further, the coatings can achieve their characteristics in the absence of a thermal activation step for achieving any cross-linking.

It is also specifically contemplated that the composition may include a de-flocculant, such as an electrolytic compound (e.g., an inorganic electrolytic compound), for helping to improve the dispersion of synthetic clay within a slurry, reduce viscosity, or both, during processing to make the compositions, in the resulting composition, or both. By way of example, one approach is to employ a sodium containing compound, such as tetra-sodium pyrophosphate, sodium carbonate, compound, or both. Other de-flocculants (e.g., alkali metal compounds, phosphates, organic compounds, or otherwise) may also be employed. Without intending to be bound by theory, it is believed that the clay will absorb the de-flocculant and increase the charged repulsive forces that exist between clay particles. The de-flocculant, when employed, may be employed in any suitable concentration. For example, one approach is to add de-flocculant to a synthetic clay slurry, prior to incorporating the slurry into the coating composition, in an amount of less than about 5 percent (or more specifically less than about 3%) by weight of the clay within the slurry. It will be appreciated that during subsequent processing of the slurry, such as during a separation step in which supernatant is separated from the synthetic clay, the de-flocculant may remain within or become removed from the clay particles.

The synthetic clay will generally be present in an amount of about 3 to about 40 weight percent of the total solids content of the composition, and more specifically about 5 to about 30 weight percent of the total solids content of the composition.

In general, the compositions herein are prepared by providing a polymeric dispersion and then admixing into the dispersion a suitable amount of the synthetic clay. Prior to admixing (although it may be possible as well during or even after the admixing), the synthetic clay may be subjected to one or more treatment steps, such as one or more steps for reducing particle agglomerations, for segregating particles by size, for reducing impurities, or any combination thereof. By way of example, the synthetic clay may be jet-milled, centrifuged, ultrasonically agitated, or any combination thereof.

By way of illustration, one possible approach to the manufacture of the coating compositions herein is to mix a desired amount of synthetic clay in a liquid medium to form a slurry (e.g., a step of mixing synthetic clay with water, such as de-ionized water). One or more additional ingredients for the final composition may be added to such slurry (e.g., a de-flocculant). The slurry is processed to reduce particle agglomerations, to separate particles by size, or both. For example, the slurry may be subjected to ultrasonic vibration, shear mixing (e.g., mixing with a Cowles blade at a relatively high shear rate, mixing in a high speed rotor-stator device, or both), or both. Centrifugation may be employed, such as for separating particles by size. A separations step may be employed by which supernatant is separated from the solids (e.g., by filtration). The slurry is then physically mixed with the polymeric dispersion, such as by gradual addition while subjecting the resulting dispersion to mechanical mixing.

Any coating of a substrate according to the teachings herein may employ suitable art-disclosed coating techniques. Without limitation, coating may be by spraying, brushing, rolling, swabbing, curtain coating, dipping, doctor blading, any combination thereof, or some other suitable technique.

The coating may be applied over a primer layer, or in the absence of a primer layer. In one preferred embodiment, the coating generally will be in direct contact with the substrate over the entirety of the coated substrate, or over at least a substantial portion of the coated substrate (e.g., contacting with the coating at least about 50% of the surface area of an exposed outer surface of the substrate). A single layer of coating may be employed. It is also possible that the coating may include a plurality of sequentially applied coating layers. Each coating layer is contemplated to include a generally uniform dispersion of the synthetic clay particles within a polymeric matrix. In one embodiment, each coating layer will have the same composition as the coating layer onto which it is applied. A suitable drying step may be employed. For example, it is possible to dry under ambient conditions at room temperature. Drying may include one or more heating steps. By way of example, heating may be at a temperature greater than about 50° C., and more preferably greater than about 60° C. Heating may be at a temperature less than 100° C. and more preferably less than about 80° C. Heating may be for more than about 5 minutes, more preferably more than about 10 minutes. Heating may be for less than 60 minutes, and more preferably less than about 40 minutes. By way of specific example, heating may be done (e.g., in a convection oven) at a temperature of about 70° C. for about 15 to 30 minutes.

When dried, coating thicknesses herein generally will be less than about 2 mils (0.05 mm), and more preferably less than about 1 mil (0.03 mm), e.g., less than about 0.7 mil (0.02 mm) or even less than about 0.5 mil (0.01 mm). For example, resulting articles, as a result of the coating (e.g., at a thickness of less than about 1 mil (0.03 mm), e.g., less than about 0.7 mil (0.02 mm) or even less than about 0.5 mil (0.01 mm), will exhibit (i) coating permeability (according to ASTM D3985-05) of about 0.01 to about 6 cc-mil/100 in²-Day Atm, and more preferably about 0.1 to about 3 cc-mil/100 in²-Day Atm; (ii) a yellowness index (according to ASTM E313-00) of less than about 6, and more preferably less than about 4; or (iii) a combination of (i) and (ii). In a preferred embodiment, the coating permeability is less than about 2.5 cc-mil/100 in²-Day Atm, and still more preferably less than about 2 cc-mil/100 in²-Day Atm.

Coated articles prepared according to the teachings herein generally will be characterized as including or consisting essentially of a polymeric substrate, and a coating in contact with the polymeric substrate, which includes a dispersion of polymeric particles (e.g., styrene-containing particles, polyurethane particles, butyl rubber-containing particles, (meth)acrylate-containing particles or a combination thereof, and a synthetic clay. The substrate may be in any suitable form. It may be a molded article, a thermally shaped article, an extruded article, a pultruded article, or an article made from some other fabrication technique.

The substrate may include a network of closed cells containing a CFC-free gas phase. The substrate may be free of voids between walls defining the cells. One specific preferred polymeric substrate will include a styrenic polymeric material, such that it may include or consist essentially of polystyrene or blend or copolymer thereof (e.g., a styrene-acrylonitrile copolymer), in a densified state, a foamed state (e.g., including closed cells) or a combination thereof. For example, one preferred substrate will be a styrenic polymeric foam that exhibits a closed cell structure throughout substantially all of its volume. The styrenic polymeric foam may be an extruded polymeric foam, such as one that has been processed for exhibiting a generally closed cell structure. As used herein, “closed cell” foam structures refer to foams having an open cell content of less than 30%, as determined by ASTM D6226-05, while “open cell” foam structures refer to an open cell content greater than or equal to 30%, as determined by ASTM D6226-05. Specific preferred closed cell foams useful herein may have an open cell content, as determined by ASTM D6226-05, of less than 20% or even less than 10%. An example of one preferred substrate is STYROFOAM™ polystyrene, more specifically STYROFOAM™ extruded polystyrene, and still more specifically STYROFOAM™ extruded polystyrene foam insulation.

It should be appreciated that reference to a “styrenic polymeric” material, in the context of the polymeric substrates herein, includes polymeric materials derived from one or more alkenyl aromatic compounds such as styrene. Suitable amounts (e.g., less than 50 percent by weight of the substrate) of copolymerizable compounds such as C₁₋₄ methacrylates and acrylates, acrylic acid, methacrylic acid, maleic acid, acrylonitrile, maleic anhydride, and vinyl acetate may be incorporated into the styrenic polymeric material.

One preferred example of a foam that is useful as a substrate herein is one in which at least 95 weight percent of the substrate is a thermoplastic selected from polystyrene, styrene-acrylonitrile copolymer, or a combination thereof (e.g., as a blend). For example, it is possible that the substrate includes from 1 to 35 percent by weight of the substrate of copolymerized acrylonitrile.

The polymeric substrate may have an average cell size of about 0.05 to about 1 mm per ASTM D3576-04, and more specifically about 0.12 to about 0.6 mm. The polymeric substrate may include a colorant (e.g., blue) over at least a portion of its volume, or possibly even throughout the entirety of its volume. It is also possible that the coating compositions herein may include a colorant as well. Thus, the substrate may have a visibly white outer surface, a colored outer surface, a printed outer surface, or any combination thereof. The substrate may be an elongated insulation member having a thickness from about 10 mm to about 100 mm. It may include a generally planar surface to which the coating composition of the present invention is contacted, a generally arcuate surface to which the coating composition is contacted, or both.

Examples of properties for the substrate include at least one, more preferably a combination of at least two or more, and still more preferably a combination of at least three or more, and even still more preferably a combination of all, of the following properties: a) a thermal resistance value at one inch (25.4 mm) thickness of at least about two ft²*hr*° F./Btu (0.35 m²*K/W), preferably at least about four ft²*hr*° F./Btu (0.7 m²*K/W) according to ASTM C578-06; b) a minimum compressive strength (psi, (kPa) per ASTM D1621-04A, at the first of 10% deformation or yield) of at least about 13 psi (90 kPa), and more preferably at least about 15 psi (104 kPa); c) a minimum flexural strength (psi, (kPa) per ASTMC203) of at least about 30(208), and more preferably at least about 40 (276); or (d) a maximum dimensional stability value (% linear change per ASTM D2126-04) of about 4, and more preferably about 2.

Accordingly, one aspect of the invention contemplates that the polymeric component used in the coating is provided in the coating composition, prior to coating, as a dispersion of particles that have been partially or fully polymerized. It is possible, however, that the polymeric component may be provided in a dissolved state, or as an emulsion.

### EXAMPLE 1

About 800 grams fluoromica (SOMASIF ME-100) is added into about 15,200 grams of de-ionized water, while stirring with a Cowles blade, to form an initial slurry. After addition, it is stirred for about 6 hours. About 2000 grams of the initial slurry is then subjected to an ultrasonic horn for about 10 minutes while stirring with a relatively small overhead stirrer. About 25 grams of 2% pyrophosphate solution is added to the slurry and the slurry is subjected to ultrasonic horn treatment for about 15 minutes, and then centrifuged at about 2500 rpm for about 10 minutes. Supernatant is separated from the centrifuged solids (and the centrifuged solids discarded). The remaining supernatant is then filtered through a Whatman #3 qualitative filter paper (and the resulting filtered solids discarded). The resulting filtrate that has passed through the filter paper is collected as a supernatant slurry. It is initially relatively clear, but over time will phase separate into two layers, namely, a clear top layer and a turbid bottom layer.

The supernatant slurry is then physically mixed with the polymeric dispersion, using a Caframo BDC3030 mixer with a Cowles blade. Thus, about 70 grams of SOMASIF ME-100 aqueous dispersion (solids=3.3%) is gradually added to about 11.17 grams of styrene-butadiene co-polymer latex (Latex DL 460NA (solids=48.7 wt. %) while stirring at about 1000 rpm. Following the addition, stirring continues for about 15 to 20 minutes. The mixture is then further mixed by a Speedmixer at 3000 rpm for about 3 to about 5 minutes. The resulting dried coating is about 30 wt. % synthetic clay, and is referred to as DL460 in Table 1. Similar results are believed possible if synthetic clays from Topy Industries, Ltd. (e.g., DMA-350, NTS or NHT) are substituted for SOMASIF ME-100.

A similar method is employed to prepare a composition containing a synthetic clay, and using a butyl rubber latex (e.g., available from Lord Corporation, under the designation Aqualast Lord BL100); resulting dispersion referred to as BL100 in Table 1), and a composition containing a synthetic clay with a polyurethane latex prepared according to the teachings of WO 2007/027921 (resulting dispersion referred to as XUR in Table 1). No surfactant is added to any of the compositions.

The above dispersions respectively are onto polystyrene film substrates (e.g., Trycite™ 1000 film, available from The Dow Chemical Company), having a thickness of about 0.032 mm (about 1.25 mils). After drying, the coated film substrate samples are analyzed for coating permeability according to ASTM D3985-05 (at a temperature of 23° C. and 60 to 80% RH). The coated film samples are analyzed for ascertaining a yellowness index according to ASTM E313-00 with a Macbeth COLOR-EYE (Model. M2020PL), from Kollmorgen Corporation. Expected results are set forth in the following Table 1.

It will be appreciated that coating permeability values in accordance with the teachings herein will be the product of the oxygen transmission rate (“OTR”) and the coating thickness, wherein the OTR value for the coating is obtained in accordance with the equation: OTR_{coating}=(OTR_{uncoated}*OTR_{coated})/(OTR_{uncoated}−OTR_{coated}), pursuant to L. K. Massey, Permeability Properties of Plastics and Elastomers 2^{nd} Ed., Plastics Design Library/William Andrew Publishing, NY (2003), incorporated by reference.

TABLE 1

| | Clay | | | |
|---|---|---|---|---|
| | Loading in | | Coating Permeability | Yellowness |
| | Dried | Coating | (cc-mil/100 in²-Day-atm) | Index |
| | Coating | Thickness | (23° C.; 60 to 80% RH) | (ASTM |
| Latex | (wt. %) | (mils) | (ASTM D3985-05) | E313-00) |
| DL460 | 30 | 0.29 | 0.51 | 3.25 |
| DL460 | 30 | 0.22 | 0.46 | 3.23 |
| DL460 | 30 | 0.18 | 0.42 | 3.28 |
| DL460* | 30 | 0.16 | 0.15 | 3.21 |
| DL460* | 30 | 0.05 | 0.08 | 3.21 |
| BL100 | 30 | 0.33 | 2.24 | 3.3 |
| BL100 | 30 | 0.23 | 1.94 | 3.27 |
| XUR | 5 | 0.43 | 2.14 | 3.14 |
| XUR | 15 | 0.12 | 0.28 | 3.37 |
| XUR | 15 | 0.21 | 0.27 | 3.2 |
| XUR | 15 | 0.31 | 0.63 | 3.1 |
| XUR | 15 | 0.1 | 0.24 | 3.06 |

The asterisk (*) denotes that these samples are prepared using the clear filtrate clay, in contrast with the other samples that use the turbid filtrate clay material of the supernatant slurry. Similar results within about 20% of the recited values are also believed possible by varying the separation steps employed. For example, as with all of the methods taught herein, one or more additional sonication steps, centrifugation steps, filtration steps or any combination thereof may be employed. Moreover, it is possible to eliminate one or more such steps.

### EXAMPLE 2

Comparative samples are prepared to illustrate the properties, respectively, of un-coated polystyrene film, and the latex dispersions of Example 1, without any synthetic clay loading, and samples loaded with vermiculite natural clay (Microlite 963). The results in the below Table 2 confirm that the coatings of the present invention (loaded with synthetic clay) improve the combination of both coating permeability and yellowness index properties, as compared with samples that are not loaded with any synthetic clay, and as compared with samples loaded with natural clay.

Without intending to be bound by theory, as supported by Table 2, one aspect of the present invention is premised upon the recognition (not just with the present example, but with natural clays generally) that natural clays (that is, clays that are excavated from the earth), unless subjected to elaborate processing conditions, tend to include a host of impurities from the ground deposits from which they originate. Consequently, even some of the best commercially available natural clay materials have anywhere from about 25 to 95% useful clay content. The remainder of the material may include a host of impurities ranging from organic materials (e.g., cellulose, lignins, etc.) to inorganic minerals or compounds (e.g., iron, silicon, or calcium compounds, or the like). Purification steps are time consuming and costly, and may vary from batch to batch, depending upon the unique composition of each batch. The level of consistency and reproducibility that is needed to assure high quality barrier property characteristics from batch to batch often renders the purification impractical. The presence of even slight uncontrolled amounts of impurity can render a particular clay useless for improving barrier properties of a coating. In contrast, because there is a significantly higher control over starting materials, and processing conditions can be consistently and reproducibly implemented to result in generally higher purity synthetic clay materials. But perhaps even more important, the known chemistry and consistent processing also affords tightly controlled and attractive properties such as color, particle dispersion capability, the ion exchange values, the particle morphology (size, aspect ratio) and many other properties. The synthetic clay materials herein are believed to exhibit generally uniform microstructure, and will exfoliate for realizing with a relatively narrow band of predictable and consistent particle sizes and aspect ratios. Further, without intending to be bound by theory, the general absence of resulting large particulate impurities potentially makes it more likely that the platelets will orient in a generally ordered structure, which is believed to help improve the ability to impart barrier characteristics to a coating.

TABLE 2

| | | | Coating Permeability | Yellow- |
|---|---|---|---|---|
| | Dry Clay | Coating | (cc-mil/100 in²-Day- | ness |
| | Loading | Thick- | atm) (23° C.; | Index |
| | (wt. % | ness | 60 to 80% RH) | (ASTM |
| Sample | of solids) | (mils) | (ASTM D3985-05) | D1925) |
| Trycite ™ | Not | NA | NA | 3.26 |
| 1000 film | applicable | | | |
| | (NA) | | | |
| DL460 (no clay) | NA | 0.51 | 322.7 | 3.72 |
| XUR (no clay) | NA | 0.93 | 39.97 | 3.4 |
| BL100 (no clay) | NA | 0.62 | 921 | 3.17 |
| XUR/Vermiculite | 2.5 | 0.55 | 15.9 | 6.15 |
| XUR/Vermiculite | 2.5 | 1.21 | 16.25 | 8.67 |
| XUR/Vermiculite | 5 | 0.49 | 8.51 | 7.47 |
| XUR/Vermiculite | 5 | 1.32 | 10.2 | 12.24 |
| XUR/Vermiculite | 30 | 0.16 | 0.12 | 13.93 |
| XUR/Vermiculite | 30 | 0.61 | 0.37 | 20.03 |

For the above samples, it is believed that the vermiculite slurry is not stable with the styrene-butadiene latex. The polyurethane latex, though it can be successfully coated onto the film substrate, is expected to be unstable and will phase separate over extended time periods.

The explanations and illustrations presented herein are intended to acquaint others skilled in the art with the invention, its principles, and its practical application. Those skilled in the art may adapt and apply the invention in its numerous forms, as may be best suited to the requirements of a particular use. Accordingly, the embodiments of the present invention as set forth are not intended as being exhaustive or limiting of the invention. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. References to an acrylic or (meth)acrylic (or derivative terms such as “acrylate”) contemplate meth-acrylics and acrylics (and corresponding derivative terms). The term “consisting essentially of” to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist essentially of the elements, ingredients, components or steps. Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps. The use of “about” or “approximately” in connection with a range applies to both ends of the range. Thus, “about 20 to 30” is intended to cover “about 20 to about 30”, inclusive of at least the specified endpoints.

What is claimed is:

1. A coating composition, comprising:
a) a polymeric component including styrene, (meth)acrylate, butadiene, butyl rubber, polyurethane, or a combination thereof; and
b) a synthetic clay;
wherein the coating composition will exhibit, in the form of a dry coating layer of less than 2 mils thickness, (i) a coating permeability (according to ASTM D3985-05 (at a temperature of 23° C. and 60 to 80% RH)) of about 0.01 to about 6 cc-mil/100 in²-Day-atm; and (ii) a yellowness index (according to ASTM E313-00) of less than about 6.

2. The coating composition of claim 1, wherein the polymeric component and the synthetic clay each include particles dispersed in water.

3. The coating composition of claim 2, wherein the polymeric component consists essentially of styrene-butadiene copolymer or a polyurethane.

4. The coating composition of any of claim 1, wherein the synthetic clay includes a swellable synthetic clay.

5. The coating composition of any of claim 4, wherein the synthetic clay consists essentially of a synthetic tetrasilicic fluoromica clay.

6. The coating composition of any of claim 1, wherein the composition is prepared according to a method that includes the steps of providing a polymeric dispersion including particles of the polymeric component, and thereafter adding to the dispersion a sufficient amount of a synthetic clay for improving the ability of the resulting coating to resist gas diffusion over time.

7. The coating composition of any of claim 1, wherein the synthetic clay is employed in an amount of about 3 to about 40 weight percent of the total solids content of the coating composition.

8. The coating composition of any of claim 1, wherein the polymeric component and the synthetic clay are both dispersed as particles in an aqueous medium that excludes volatile organic compounds.

9. The coating composition of claim 1, wherein the particles of the synthetic clay that have an average particle aspect ratio of about 2000:1 to about 10:1.

10. The coating composition of any of claim 9, wherein the coating composition is free of any added surfactant.

11. The coating composition of any of claim 1, wherein the coating composition is in the form of a coating layer on a polymeric substrate.

12. The coating composition of any of claim 11, wherein the coating composition is in the form of a coating layer having a thickness of less than about 0.03 mm (1 mil) on a polymeric substrate that includes a styrenic polymeric material.

13. A coating composition, wherein the polymeric component includes styrene-butadiene particles, polyurethane particles, or a combination thereof; the synthetic clay includes particles of a synthetic tetrasilicic fluoromica clay that is free of any functionalization; and the coating composition includes an aqueous medium that excludes volatile organic compounds; wherein the particles of the synthetic clay have an average particle aspect ratio of about 1500:1 to about 100:1; wherein the synthetic tetrasilicic fluoromica clay is employed in an amount of about 3 to about 40 weight percent of the total solids content of the coating composition; and wherein the composition is exclusive of any added surfactant.

14. A coated article, comprising:
a) a substrate:
b) a coating on the substrate:
(i) that has a thickness less than about 1 mil, and
(ii) that includes a polymeric component selected from styrene-butadiene or polyurethane, and a synthetic tetrasilicic fluoromica clay including about 3 to about 40 percent by weight of coating solids of clay particles that have an average effective aspect ratio of about 2000:1 to about 10:1;
wherein the coating will exhibit in the form of a dry coating layer of less than 1 mil thickness (i) a coating permeability (according to ASTM D3985-05(at a temperature of 23° C. and 60 to 80% RH)) of about 0.01 to about 6 cc-mil/100 in²-Day Atm (ii) a yellowness index (according to ASTM E313-00) of less than about 6, and more preferably less than about 4; or (iii) a combination of (i) and (ii).

15. The article of claim 14, wherein the coating composition will exhibit, in the form of a dry coating layer of less than 1 mil thickness, (i) a coating permeability (according to ASTM D3985-05 (at a temperature of 23° C. and 60 to 80% RH)) of about 0.1 to about 3 cc-mil/100 in²-Day-atm.

16. The article of claim 14, wherein the substrate is an elongated styrenic polymeric insulation member having a thickness from about 10 mm to about 100 mm, and wherein the substrate includes a generally planar surface to which the coating is contacted, a generally arcuate surface to which the coating is contacted, or both.

17. The article of any of claim 14, wherein (i) at least a portion of the substrate includes a network of closed cells containing a CFC-free gas phase, (ii) the substrate is free of voids between walls defining the cells, or (iii) both (i) and (ii).

18. The article of any of claim 17, wherein the substrate exhibits a combination of the following properties: a) a thermal resistance value at one inch (25.4 mm) thickness of at least about two ft²*hr*° F./Btu (0.35 m²*K/W), according to ASTM C578-06; b) a minimum compressive strength (psi, (kPa) per ASTM D1621-04A, at the first of 10% deformation or yield) of at least about 13 psi (90 kPa); c) a minimum flexural strength (psi, (kPa) per ASTMC203) of at least about 30 (208); and (d) a maximum dimensional stability value (% linear change per ASTM D2126-04) of about 4.

19. The article of any of claim 18, wherein the substrate includes a colorant for imparting a substantially uniform color throughout the substrate.

20. The article of any of claim 14, wherein the substrate is an elongated extruded styrenic polymeric substrate (i) including a network of closed cells containing a CFC-free gas phase, having an average cell size of about 0.1 to about 1 mm per ASTM D3576-04, and (ii) exhibiting a combination of the following properties: (a) a thermal resistance value at one inch (25.4 mm) thickness of at least about two ft²*hr*° F./Btu (0.35 m²*K/W), according to ASTM C578-06; (b) a minimum compressive strength (psi, (kPa) per ASTM D1621-04A, at the first of 10% deformation or yield) of at least about 13 psi (90 kPa); (c) a minimum flexural strength (psi, (kPa) per ASTMC203) of at least about 30 (208); and (d) a maximum dimensional stability value (% linear change per ASTM D2126-04) of about 4; the coating on the substrate has a thickness less than about 1 mil, and includes a polymeric component selected from styrene-butadiene or polyurethane, and a synthetic tetrasilicic fluoromica clay including about 5 to about 30 percent by weight of coating solids of clay particles that have an average effective aspect ratio of greater than about 450:1; and wherein the coating will exhibit in the form of a dry coating layer of less than 1 mil thickness (i) a coating permeability (according to ASTM D3985-05(at a temperature of 23° C. and 60 to 80% RH)) of less than about 2.5 cc-mil/100 in²-Day Atm (ii) a yellowness index (according to ASTM E313-00) of less than about 4; or (iii) a combination of (i) and (ii).
